(19) United States
(12) Patent Application Publication
(10) Pub. No.: US 2004/0017356 A1
(43) Pub. Date: Jan. 29, 2004

(54) Pointer control device

(75) Inventor: Gary Cheng, Taipei (TW)

Correspondence Address: BACON & THOMAS, PLLC, 625 SLATERS LANE, FOURTH FLOOR, ALEXANDRIA, VA, 22314

(73) Assignee: INVENTEC CORPORATION, Taipei (TW)

(21) Appl. No.: 10/201,919

(22) Filed: Jul. 25, 2002

(51) Int. Cl. G09G 5/08

(52) U.S. Cl. 345/161

(57) ABSTRACT

The invention is to provide a pointer control device having a screen and a main system internally equipped with a central processing unit, wherein the said central processing unit is connected to a pointing stick projecting from an easily accessible controlling area on the surface of the said main system, and a module inset at another easily accessible controlling area on the surface of the said main system and having an appropriately situated touch pad with a first function key and a second function key arrayed near one end as well as a third function key and a fourth function key near its other end, enabling a pointer to be displayed on the said screen having several operating models for the user to freely select an appropriate one.

### BACKGROUND OF THE INVENTION

1) Field of the Invention

The invention herein relates to computer inputting mechanisms, specifically a pointer control device

2) Description of the Prior Art

The contemporary world is in an age of rich information growth and the rapid development of computer-generated high technology products. This is not only bringing people closer together, but narrowing the distance between time and space and, furthermore, in a manner that is inseparable from our lives. With the continuous release of new information products nowadays, especially the widespread utilization of notebook computers, portable computer quality requirements have been raised by popular demand. Whether future portable computers are capable of providing more convenience and more effective service has become a major indicator in the evaluation of the information product manufacturing technology of various nations that will determine which country is in the lead.

Early generation portable computers were not lightweight and weighed approximately seven to fourteen kilograms. While later laptop computers ranged from four to seven kilograms in weight, currently available notebook computers are now only one to four kilograms. In terms of structural weight or physical dimensions, their research and development in has in addition to a continuous focus on lighter, thinner, shorter, and more compact designs also included a constant emphasis on all-in-one designs. Looking at the present information market and the fierce degree of sales competition therein, needless to say, given the situation of countless brands of notebook computers on the information market, although each company is under enormous pressure to achieve marketing gains, this situation has also increased consumer selection opportunities, therefore, the capability to offer ergonomic, multifunctional all-in-one notebook computers at reasonable prices will be another factor of competition among computer companies.

A notebook computer, by definition, resembles a notebook in that it typically can be opened or closed and thus is advantageously portable, and consists of a screen and a main system as well as a minimum of one hinge pin conjoining them such that the bezel of the said screen when horizontal covers the said main system. When a user wants to utilize the said notebook computer, it is only necessary to open the said screen by axially pivoting the said screen on the said hinge pin to an appropriate position and angle, following which the user can input data into the said main system by means of a keyboard disposed on the said main system, with the said main system utilizing a communications line to forward the said data to the said screen such that the said screen displays the related data content. However, due to the prolific development of various application software, especially widely utilized graphical user interface operating systems (for example, Windows), if only the said keyboard serves as the primary means of commanding the said operating systems, then a number of operating inconvenience occur. For example, with respect to the pointer or icons displayed on the said screen, if only the said keyboard is available to control the movement and direction of the said pointer or serves as the sole means to open the said icons, this results in numerous operating inconveniences and difficulties. Therefore, in addition to a said keyboard, the notebook computer is often also equipped with a pointing device to simplify the operating procedures of the said operating system and enhance the controllability of the said pointer.

In present personal computers, the most commonly utilized input device besides the keyboard is the mouse; the said mouse is a type of pointing device and the so-called pointing device by definition refers to an input device capable of controlling the pointer and, generally speaking, utilized as a pointer control device on computers to operate graphical user interface operating systems (such as Windows) or other application software that is very convenient. As times changed, various pointer control devices having equivalent mouse functions were continuously researched and developed and, furthermore, widely utilized on notebook computers to the extent they became standard accessories on notebook computers, with the examples including:

1. Pointing sticks (also referred to as track sticks); the said pointing sticks are constructed of a rubber material, have a columnar appearance, and typically installed projecting among certain keys in the keyboard; its operation is based on mechanical tactility that only requires the placement of a fingertip on the said pointing stick, following which the said notebook computer responds to the movement and direction of the fingertip on the said pointing stick, thereby enabling control over pointer movement and direction.

2. Touch pads are a type of pointer control device frequently utilized on notebook computers; extremely simple to operate, it only requires moving a fingertip on the said touch pad, with the said touch pad responding to the movement and direction of fingertip pressure applied against the said touch pad and resulting in control over pointer movement and direction.

However, in addition to external mouse connection capability on the said main system, conventional notebook computers are now typically equipped with a said touch pad having two function keys built into the touch pad or an installed said pointing stick having two function keys integrated into the said pointing stick; in other words, besides the said mouse, the said pointing stick and the said touch pad are often one of the only two options available for utilization on the said notebook computers. However, the current research and development theme of various computer manufacturers, as previously mentioned, includes a constant emphasis on all-in-one designs among their research and development objectives. As a result, in the current harsh competition in the information market, an all-in-one machine must be released before a leading position in the information market can be occupied and one can easily realize that the capability to offer ergonomic, multifunctional all-in-one notebook computers, such as units equipped with a range of pointing control devices for multiple applications and support, and at reasonable prices will be another factor that determines competitiveness among computer companies.

### SUMMARY OF THE INVENTION

In view of the fact that the said conventional notebook computer, with respect to pointer control device utilization, is in addition to external mouse connection capability typically equipped with a said touch pad having two function keys built into the touch pad or an installed said pointing stick having two function keys integrated into the said pointing stick, but the said pointing stick and the said touch pad are often one of the only two options available for utilization on the said notebook computers and, furthermore, the current research and development theme of various computer manufacturers includes a constant emphasis on all-in-one designs among their research and development objectives, therefore, to improve the said shortcomings as well as support research and development trends the inventor of the invention herein conducted long-term, extensive research and experimentation that culminated in the successful development and design of the pointer control device of the invention herein that points on the screen of a notebook computer, with the pointer displayed on the said screen having several operating models that enables the user of the said notebook computer to freely select an appropriate operating model.

The above and other objects, features and advantages of the present invention will become apparent from the following detailed description taken with the accompanying drawings.

### BRIEF DESCRIPTION OF THE DRAWINGS

FIG. 1 is an isometric drawing of the invention herein.

FIG. 2 is another isometric drawing of the invention herein.

FIG. 3 is diagram of the invention herein.

### DETAILED DESCRIPTION OF THE INVENTION

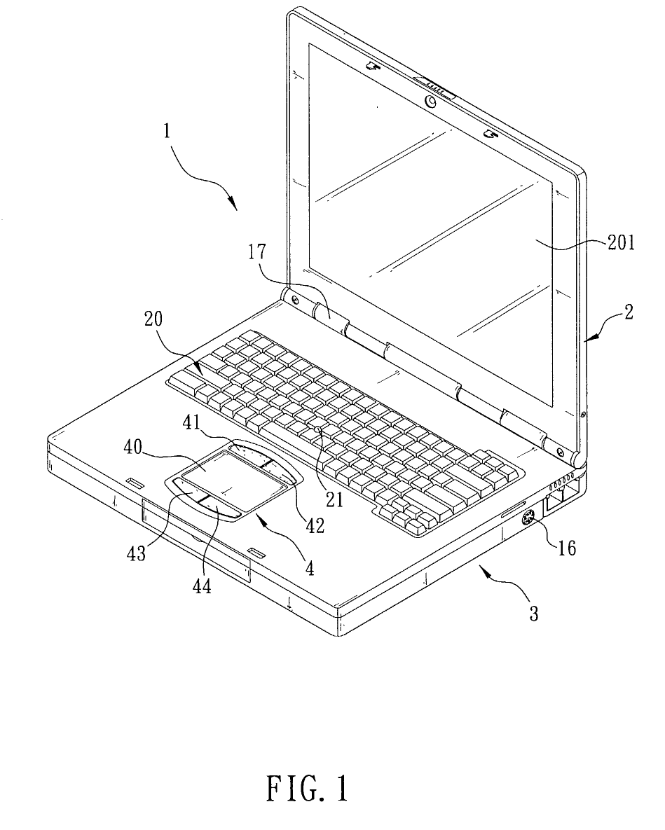

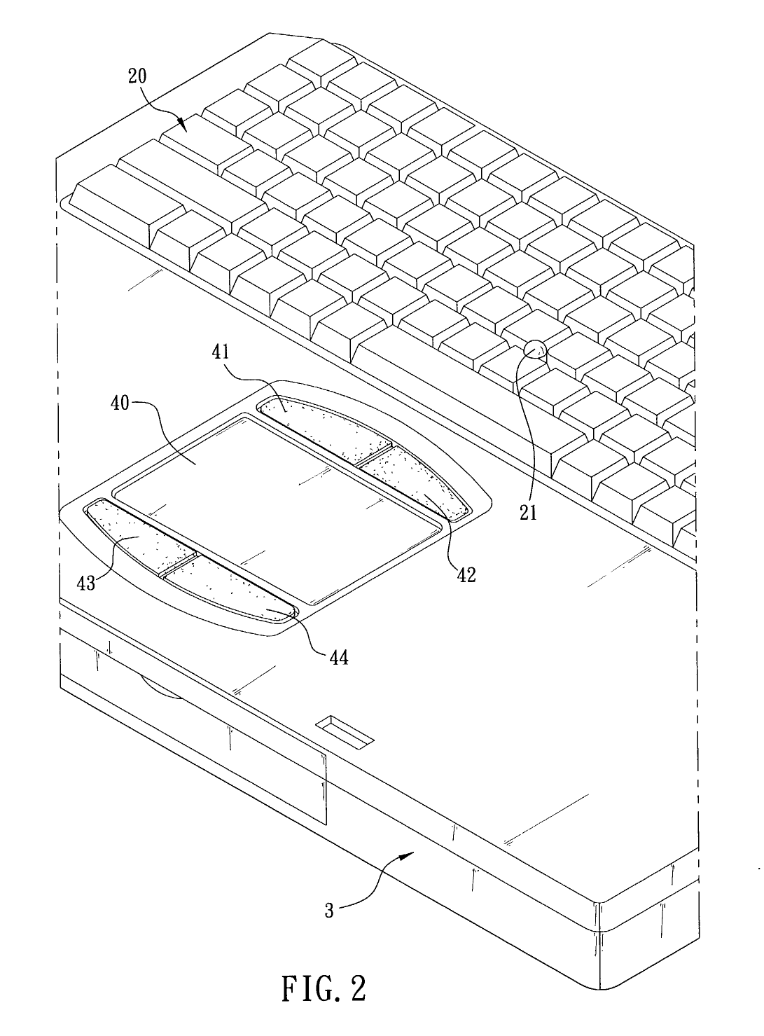

The invention herein is a pointer control device, referring to FIG. 1 and FIG. 2, comprised of an electronic device (such as a notebook computer) 1, the said electronic device 1 having a main system 3 and a screen 2, with a minimum of one interconnective circuit component between the said main system 3 and the said screen 2 that serves as a data medium that forwards data to and from the said main system 3 and the said screen 2, enabling the said screen 2 to display the matching information content; a keyboard 20 is situated near the center of the said main system 3 and a plurality of keys are disposed on the said keyboard 20; a pointing stick 21 projects from a certain position among the said keys; a module 4 is inset in the surface between one end of the said main system 3 and the said keyboard 20; and a touch pad 40 is situated at the center of the module 4, with a first function key 41 and a second function key 42 arrayed near one end as well as a third function key 43 and a fourth function key 44 near its other end; as such, the user operates the said pointing stick 21 or the said touch pad 40 to control how the pointer is tracked across the screen 2 and then utilizes the said function keys 41, 42, 43, and 44 to select an icon or option displayed on the said screen 2, or execute an assigned function.

In the invention herein, referring again to FIG. 1 and FIG. 2, the said electronic device 1 can be a notebook computer and the said interconnective circuit component can be a signal transmission line such that the said main system 3 forwards data to the said screen 2 via the said signal transmission line and the content of the said data is displayed through the bezel 201 of the said screen 2; a minimum of one hinge pin 17 is installed at one end of the said main system 3 that is conjoined to the said main system 3 such that the bezel 201 of the said screen 2 can be covered over the said main system 3 and, furthermore, when the user wants to operate the said electronic device 1, the said screen 2 is rotated on the said hinge pin 17 until an appropriate operating position and angle are reached; and a minimum of one external mouse can be plugged into an input port 16 situated at an appropriate position on the said electronic device 1 and, furthermore, the said input port 16 can be a USB (Universal Serial Buss) interface.

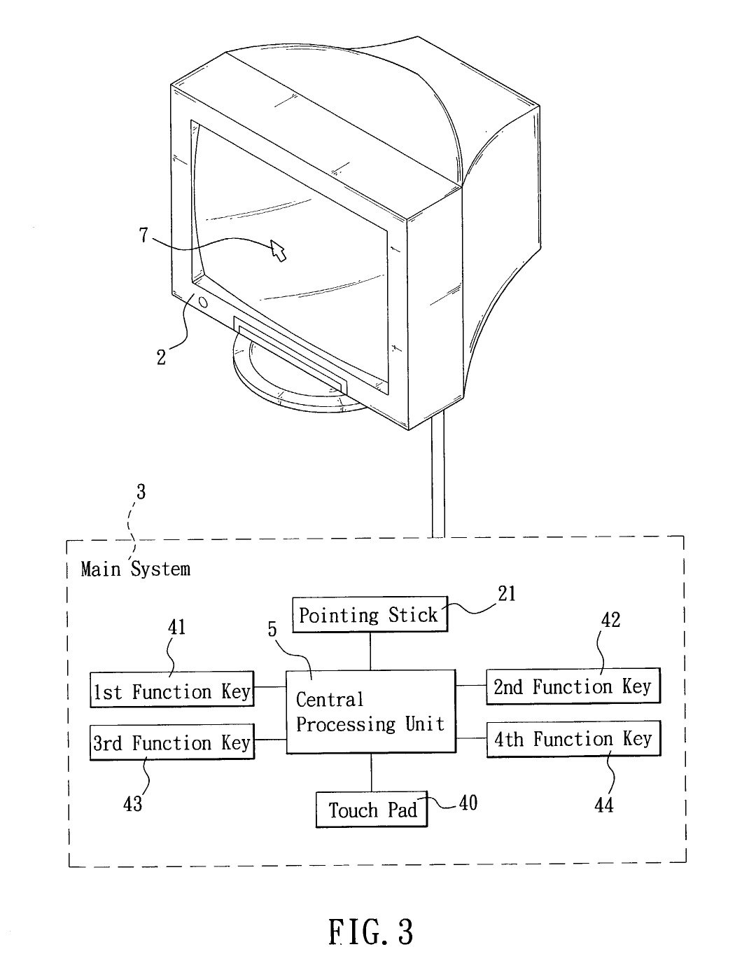

In the invention herein, referring to FIG. 3, the said main system 3 is internally equipped with a central processing unit 5, with the said pointing stick 21, the said first function key 41, the said second function key 42, the said touch pad 40, the said third function key 43, and the said fourth function key 44 all connected to the said central processing unit 5 such that the user has many control means to display the pointer 7 on the said screen 2; in other words, the said pointing stick 21, the said first function key 41, the said second function key 42, the said touch pad 40, the said third function key 43, and the said fourth function key 44 can be flexibly utilized in a plurality of the control combinations; for example, the said pointing stick 21 and the said touch pad 40 can be utilized in combination with the said first function key 41 and the said second function key 42, in combination with the said third function key 43 and the said fourth function key 44, or in combination with the said first function key 41 and the said fourth function key 44.

While the invention herein disclosed has been described by means of specific embodiments, numerous modifications and variations could be made thereto by those skilled in the art without departing from the scope and spirit of the invention set forth in the claims.

1. A pointer control device comprised of an electronic device, the said electronic device having a main system and a screen, wherein the said main system is internally equipped with a central processing unit and the said central processing unit is connected to each of the following components:
a pointing stick projecting from an easily accessible controlling area on the surface of the said main system.
a module inset at another easily accessible controlling area on the surface of the said main system, the said module having an appropriately situated touch pad, with a first function key and a second function key arrayed near one end as well as a third function key and a fourth function key near its other end.

2. A pointer control device as claimed in claim 1 in which the said electronic device can be a notebook computer.

3. A pointer control device as claimed in claim 1 in which the said electronic device has a minimum of one mouse input port.

4. A pointer control device as claimed in claim 3 in which the said input port can be a USB (Universal Serial Bus) interface.

5. A pointer control device as claimed in claim 2 in which the said notebook computer has a keyboard is situated near the center of its surface; a plurality of keys are disposed on the said keyboard and the said pointing stick is located at a suitable position among the said keys.

6. A pointer control device as claimed in claim 5 in which the said keyboard is inset between the said screen and the said module.
